(19) United States
(12) Patent Application Publication
(10) Pub. No.: US 2023/0021679 A1
(43) Pub. Date: Jan. 26, 2023

(54) METHOD FOR POLYMERISING AN AQUEOUS SUSPENSION OF STYRENE USING AT LEAST ONE ORGANIC HEMIPEROXYACETAL PEROXIDE

(71) Applicant: ARKEMA FRANCE, Colombes (FR)

(72) Inventors: Bruno VAN HEMELRYCK, PIERRE-BENITE CEDEX (FR); Isabelle MASI, PIERRE-BENITE CEDEX (FR)

(21) Appl. No.: 17/783,321

(22) PCT Filed: Dec. 18, 2020
(86) PCT No.: PCT/FR2020/052541

§ 371 Date: Jun. 8, 2022

(30) Foreign Application Priority Data
Dec. 18, 2019 (FR) FR1914739

(51) Int. Cl. C08F 12/08; C08J 9/20; C08J 9/14

(52) U.S. Cl. CPC C08F 12/08; C08J 9/20; C08J 9/141; C08J 2325/06

(57) ABSTRACT

The present invention relates to a method for polymerising an aqueous suspension of styrene using at least one organic hemiperoxyacetal peroxide, the method comprising a step a) of keeping the aqueous suspension of styrene comprising the organic hemiperoxyacetal peroxide at a temperature below the 1-hour half-life temperature of the organic hemiperoxyacetal peroxide, preferably at 5 to 25° C. below the 1-hour half-life temperature of the organic peroxide, for at least 30 minutes.

The present invention relates to a process for the preparation of expandable polystyrene and also to an expandable polystyrene which can be obtained by such a process.

One of the known methods for the production of polymers of expandable polystyrene type, referred to as EPS subsequently, is the polymerization in aqueous suspension. This is generally a process of batch type in which two or more polymerization initiators which are soluble in the monomer are employed, with a temperature profile which increases stepwise. It has also been proposed to inject the initiators continuously into the reactor during the polymerization. The initiators of the process are chosen as a function of their half-life temperature, in order to feed the polymerization with radicals in a controlled manner at chosen points in the temperature profile, so that efficient conversion is obtained over an acceptable period of time. In the polymerization of styrene, it is more practical to describe the decomposition performance qualities of the initiator in terms of half-life temperature for 1 h, defined as being the temperature sufficient to cause the decomposition of half of the initial concentration of initiator in one hour.

Conventionally, the suspension polymerization intended to prepare the EPS is carried out in a process using two different stationary temperature phases and two initiators, an initiator of first stationary phase and an initiator of second stationary phase or “finish”; these two initiators have different half-life temperatures, each appropriate to the corresponding stationary temperature phase. In such a process, dibenzoyl peroxide (BPO) is often employed as initiator of first stationary phase at a reaction temperature of between approximately 82° C. and 95° C. The other initiators of first stationary phase which can be employed in this temperature range can include tert-butyl peroxy-2-ethylhexanoate, tert-amyl peroxy-2-ethylhexanoate and 2,5-dimethyl-2,5-di(2-ethylhexanoylperoxy) hexane. Initiators such as tert-butyl peroxybenzoate (sold by Arkema under the name Luperox® P), OO-tert-butyl O-(2-ethylhexyl) monoperoxycarbonate (sold by Arkema under the name Luperox® TBEC) and OO-tert-amyl O-(2-ethylhexyl) monoperoxycarbonate (sold by Arkema under the name Luperox® TAEC) are widely employed for the high temperature stationary phase, or second stationary phase, at a temperature between 115° C. and 135° C. The second stationary phase is generally a finishing stage used to minimize the amount of residual monomer in the EPS. In processes having a commercial purpose, this stage is often carried out at a temperature of greater than 120° C. for a prolonged period of time in order to reduce the amount of monomer down to a content of less than 1000 ppm judged acceptable by the profession. The characteristic failings of the conventional process are: in the first stationary phase, the high reaction duration necessary to obtain a conversion sufficient to close the reactor when a desired size of polystyrene particles is reached and, in the second stationary phase, the relatively high finishing temperatures required.

The use of the hemiperoxyacetal 1-methoxy-1-(tert -amylperoxy)cyclohexane has been proposed for replacing the benzoyl peroxide conventionally employed around 88-92° C. for the first stage of main conversion. Nevertheless, as the half-life temperature for 1 h (HLT 1 h) of this type of peroxide is higher than that of BPO, it is necessary to carry out the polymerization at a higher temperature (typically 105-111° C.) in order to make possible a faster main conversion. The adoption, for the first conversion stage, of a polymerization temperature greater than the boiling point of the water/styrene mixture leads to numerous operating constraints. First of all, it is impossible to operate the first stage in an open reactor and thus to monitor the growth of the polystyrene (PS) particles being formed by simple manual sampling during polymerization so as to optionally readjust the suspension system. Any variation in the efficiency of the suspension system thus cannot be detected except by using fast cameras making it possible to monitor the growth of the PS particles in the reaction mixture, this being done at the cost of a major investment. Moreover, the thermal profile of the first conversion stage requires a much greater cooling capacity than that necessary for the conversion usually carried out with benzoyl peroxide. This can thus result in a risk of runaway of the reaction if the cooling capacity is not sufficient or if the system for servo-control of the cooling is not fast enough.

In order to overcome the very high heat flux generated by rapid polymerization kinetics with the initiators of hemiperoxyacetal type, it has been proposed to inject the organic peroxide continuously, which eliminates the risk of runaway while making possible more uniform generation of initiator radicals. This solution secures the polymerization by avoiding runaway at the start of conversion but does not however deal with the problem posed by the impossibility of easily monitoring the growth of the particles and requires the installation of a specific item of equipment, such as a tank, an additional pump and safety devices in order to carry out the injection of the organic peroxide continuously.

It has been discovered, surprisingly, that a specific process made it possible to return to a more conventional situation of an open reactor during the first phase of polymerization operated at the same temperature as that produced with BPO usually, thus authorizing the use of a conventional item of equipment and control of polystyrene particles, while shortening the production cycle, thus making it possible to increase the production of polymer compared with the processes conventionally used.

Thus, the present invention relates to a process for the polymerization of an aqueous styrene suspension using at least one organic hemiperoxyacetal peroxide, said process comprising a stage a) of maintenance of said aqueous styrene suspension comprising said organic hemiperoxyacetal peroxide at a temperature lower than the half-life temperature for 1 h of said organic hemiperoxyacetal peroxide, preferably lower by 5 to 25° C. than the half-life temperature for 1 h of said organic peroxide, for at least 30 minutes. Within the meaning of the present invention, the term “maintenance of the temperature” is understood to mean that the temperature remains constant throughout the duration of stage a) or of stage b) of the process.

The term “constant temperature” is understood to mean a maximum temperature difference between the minima and the maxima of said stage of less than 10° C., preferably of less than 5° C., preferably of less than 2° C., more preferentially of less than 1° C., more preferentially of less than 0.5° C. It is understood that said minima and maxima remain within the temperature range defined below for each of stages a) and b).

Within the meaning of the present invention, the term “of between . . . and . . . ” is understood to mean that the limits are included.

### Organic Peroxide (Hemiperoxyacetal)

The at least one organic peroxide used in accordance with the present invention is chosen from the group consisting of hemiperoxyacetals.

The term “hemiperoxyacetal” is understood to mean a compound of general formula (R₃)(R₄)C(—OR₁)(—OOR₂) in which:
R₁ represents a linear or branched, preferably C₁-C₁₂, preferably C₁-C₄, more preferably C₁, alkyl group or a cycloalkyl group with R₂,
R₂ represents a linear or branched, preferably C₁-C₁₂, preferably C₄-C₁₂, more preferably C₅, alkyl group or a cycloalkyl group with R₁,
R₃ represents a hydrogen or a linear or branched, preferably C₁-C₁₂, more preferably C₄-C₁₂, alkyl group or a cycloalkyl group with R₄,
R₄ represents a hydrogen or a linear or branched, preferably C₁-C₁₂, more preferably C₄-C₁₂, alkyl group or a cycloalkyl group with R₃.

Preferably, R₃ forms a cycloalkyl group with R₄.

Preferably, when R₃ is a hydrogen, R₄ is a linear or branched, preferably C₁-C₁₂, more preferably C₄-C₁₂, alkyl group.

Preferably, the organic peroxide is chosen from the group consisting of hemiperoxyacetals having a half-life temperature for 1 h of between 100° C. and 120° C., preferably between 104° C. and 116° C., more preferably still between 104° C. and 110° C.

The term “half-life temperature for 1 h” represents the temperature for which half of the organic peroxide has decomposed in one hour and at atmospheric pressure. Conventionally, the “half-life temperature for 1 h” is measured in n-decane or n-dodecane.

Preferably, the organic peroxide according to the invention is chosen from the group consisting of the hemiperoxyacetals corresponding to the following general formula (I):

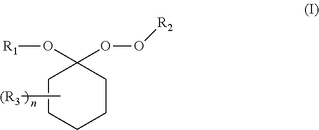

in which formula (I):
R₁ represents a linear or branched C₁-C₄, preferably C₁, alkyl group,
R₂ represents a branched C₄-C₁₂, preferably C₄-C₈, more preferably C₅, alkyl group,
R₃ represents a linear or branched C₁-C₄, preferably C₁-C₃, alkyl group,
n denotes zero or an integer varying from 1 to 3.

Preferably, R₁ represents a linear, in particular C₁-C₂, more preferentially C₁, alkyl group.

Preferably, R₂ represents a branched C₄-C₅, more preferentially C₅, alkyl group.

Preferably, n denotes zero.

Preferably, R₃ represents a C₁-C₂, more preferentially C₁, alkyl group.

Preferentially, in the formula (I), R₁ represents a C₁-C₂ alkyl group, R₂ represents a branched C₄-C₅ alkyl group and n denotes zero.

More preferentially still, in the formula (I), R₁ represents a Ci alkyl group, R₂ represents a branched C₅ alkyl group and n denotes zero.

Preferably, the organic peroxide(s) is or are chosen from the group consisting of 1-methoxy-1-(tert-amylperoxy)cyclohexane (TAPMC), 1-methoxy -1-(t-butylperoxy)cyclohexane (TBPMC), 1-methoxy-1-(t-amylperoxy)-3,3,5-trimethylcyclohexane, 1-ethoxy-1-(t-amylperoxy)cyclohexane, 1-ethoxy-1-(t -butylperoxy)cyclohexane, 1-ethoxy-1-(t-butyl)-3,3,5-peroxycyclohexane and their mixtures.

More preferentially still, the organic peroxide according to the invention is 1-methoxy-1-(tert-amylperoxy)cyclohexane (TAPMC).

Preferably, the hemiperoxyacetal content is of between 0.05% and 3% by weight, with respect to the weight of the styrene monomers, preferably of between 0.1% and 2% by weight, with respect to the weight of the styrene monomers, and more preferentially still between 0.3% and 1% by weight, with respect to the weight of the styrene monomers.

### Additional Organic Peroxide

In one embodiment of the invention, the aqueous suspension moreover comprises at least one additional organic peroxide different from said organic hemiperoxyacetal peroxide.

Said additional organic peroxide can be present in the suspension before stage a) or be added during stage a) or after stage a), in particular during stage b).

Preferably, said additional organic peroxide is added before stage a), more preferably during or just after stage a′) of preparation of the aqueous suspension comprising styrene, more preferentially just after stage a′).

Said additional organic peroxide can preferably be chosen from all initiators of organic peroxide type different from the hemiperoxyacetals and the half-life temperature for 1 h of which is of between 105° C. and 130° C., preferably is of between 110° C. and 122° C.

In one of the embodiments of the invention, the additional organic peroxide is chosen from the group consisting of OO-t-alkyl O-alkyl monoperoxycarbonates, where the t-alkyl group comprises between 4 and 12 carbon atoms, preferentially between 4 and 5 carbon atoms, and the alkyl group comprises between 3 and 12 carbon atoms and preferentially 8 carbon atoms, and their mixtures.

Preferably, said additional organic peroxide is chosen from the group consisting of OO-t-amyl O-2-ethylhexyl monoperoxycarbonate (TAEC) and OO-t-butyl O-2-ethylhexyl monoperoxycarbonate (TBEC), more preferentially is OO-t-amyl O-2-ethylhexyl monoperoxycarbonate.

These products TAEC and TBEC are sold by Arkema under the respective brand names Luperox® TAEC and Luperox® TBEC.

According to another preferred embodiment, the additional organic peroxide is chosen from the group consisting of peracetals, preferably chosen from the group consisting of 1,1-di(tert-alkylperoxy)cyclohexane, preferably 1,1-di(tert-amylperoxy)cyclohexane (sold under the name Luperox® 531 by Arkema), 1,1-di(tert-alkylperoxy)-3,3,5 trialkylcyclohexane, preferably 1,1-di(tert -butylperoxy)-3,3,5 trimethylcyclohexane (sold under the name Luperox® 231 by Arkema), 2,2-di(4,4-di(tert-alkylperoxy)cyclohexyl)alkane, preferably 2,2-di(4,4-di(tert-butylperoxy)cyclohexyl)propane, and polyether poly(tert-alkylperoxy carbonate), preferably polyether poly(tert-butylperoxy carbonate) (sold under the name JWEB50 by Arkema).

Alternatively, the additional organic peroxide is chosen from the group consisting of diacyl peroxides, preferably diacyl peroxides having a half-life temperature of between 80 and 100° C., more preferentially of between 85 and 95° C., more preferentially is dibenzoyl peroxide (sold under the name Luperox® A 75 by Arkema).

Preferably, the ratio by weight of the hemiperoxyacetal to the additional organic peroxide is of between 20:1 and 2:1, more preferentially is of between 15:1 and 5:1, more preferentially is of between 11:1 and 9:1.

Preferably, the second organic peroxide promotes the final conversion of the styrene.

In a specific embodiment, the aqueous suspension does not comprise OO-t-butyl O-(2-ethylhexyl) monoperoxycarbonate (TBEC), preferably does not comprise any monoperoxycarbonate or hydroperoxide, and more preferentially does not comprise a second organic peroxide which is an initiator of polymerization of styrene, preferably does not comprise any organic peroxide other than a hemiperoxyacetal and particularly advantageously does not comprise a second organic peroxide.

In a specific embodiment, no OO-t-butyl O-(2-ethylhexyl) monoperoxycarbonate (TBEC), preferably no monoperoxycarbonate or hydroperoxide, and more preferentially no second organic peroxide which is an initiator of polymerization of styrene, preferably no organic peroxide other than a hemiperoxyacetal and particularly advantageously no second organic peroxide is present in the process according to the present invention.

### Stage a) (First Stationary Phase)

Preferably, stage a) lasts at least 30 minutes, preferably between 1 and 4 hours, preferentially between 2 and 3 hours, more preferentially approximately 2 hours 30 minutes.

Thus, the process according to the invention makes it possible to considerably reduce the time of the first stage of conversion of the styrene compared with the processes of the prior art, for which the first stationary temperature phase is approximately 4 hours.

Preferably, stage a) is carried out at a temperature lower by 5 to 25° C. than the half-life temperature for 1 h of said organic hemiperoxyacetal peroxide, preferably lower by 6 to 25° C. than the half-life temperature for 1 h of said organic hemiperoxyacetal peroxide, more preferentially still lower by 10 to 20° C. than the half-life temperature for 1 h of said organic hemiperoxyacetal peroxide. Preferentially, stage a) is carried out at a temperature ranging from 80° C. to 100° C., preferably from 80° C. to less than 100° C., preferentially at a temperature ranging from 81° C. to 99° C., preferentially at a temperature ranging from 85° C. to 95° C., preferentially between 88° C. and 93° C. and more preferentially at a temperature of approximately 90° C.

Thus, the process according to the invention makes it possible to considerably reduce the heating temperature of the first stage of conversion of the styrene compared with the processes of the prior art using organic hemiperoxyacetal peroxides in which the first stage of conversion is carried out at a temperature of approximately 110° C.

In addition, the process of the invention makes possible the monitoring of the growth of the polystyrene particles, by regular withdrawals of samples from the reaction medium in an open reactor. This could not be envisaged with the processes of the prior art using organic hemiperoxyacetal peroxides, which require working with closed reactors due to the much higher heating temperature of the first stage.

In order to reach the temperature of stage a), it is necessary to heat the system. This transition stage between the initial temperature of the system, which generally corresponds to a temperature of between 5° C. and 50° C., and the temperature of stage a) is called “gradient”.

Preferably, the gradient to reach the temperature of stage a) is carried out in at least 30 minutes.

Preferably, the gradient to reach the temperature of stage a) is carried out in less than 1 h 30.

Particularly preferably, the gradient to reach the temperature of stage a) is carried out in between 30 minutes and 1 h 30.

### Stage b) (Second Stationary Phase)

Preferably, said process comprises a stage b), subsequent to stage a), of maintenance of said suspension at a temperature greater than or equal to the half-life temperature for 1 h of said organic hemiperoxyacetal peroxide, preferably greater by 5 to 25° C. with respect to the half-life temperature for 1 h of said hemiperoxyacetal, for at least 30 minutes.

Preferably, stage b) lasts at least 30 minutes, preferably between 1 and 4 hours, preferentially between 2 and 3 hours, more preferentially approximately 2 hours 30 minutes.

Preferably, stage b) is carried out at a temperature greater than or equal to the half-life temperature for 1 h of said organic hemiperoxyacetal peroxide, more preferentially at a temperature of between the half-life temperature for 1 h of said organic hemiperoxyacetal peroxide and said half-life temperature+30° C. Preferentially, stage b) is carried out at a temperature ranging from 105° C. to 140° C., more preferentially at a temperature ranging from 110° C. to 130° C. and more preferentially at a temperature of approximately 115° C. Thus, the process according to the invention makes it possible to considerably reduce the heating temperature of the second stage of conversion of the styrene compared with the processes of the prior art using organic hemiperoxyacetal peroxides. This thus exhibits an advantage in terms of saving in energy but also in time required to pass from the temperature of stage a) to the temperature of stage b).

In order to pass from the temperature of stage a) to the temperature of stage b), it is necessary to heat the system further. This transition stage between stage a) and stage b) is called “gradient”. Preferably, the gradient between stage a) and stage b) is carried out in at least 30 minutes.

Preferably, the gradient to reach the temperature of stage b) is carried out in less than 1 h 30.

Particularly preferably, the gradient to reach the temperature of stage b) is carried out in between 30 minutes and 1 h 30.

### Stage a′) of Preparation of the Aqueous Suspension

Preferably, the process according to the invention comprises a stage a′) of preparation of the aqueous suspension comprising styrene monomers and at least one organic hemiperoxyacetal peroxide. Preferably, this stage a′) is carried out by mixing an aqueous suspension comprising the styrene to be polymerized and said organic hemiperoxyacetal peroxide.

Within the meaning of the present invention, the term “aqueous styrene suspension” is understood to mean an aqueous suspension comprising styrene monomers to be polymerized.

In one embodiment, the aqueous suspension also comprises other comonomers, different from styrene, carrying ethylenic unsaturations, for example alkylstyrenes, α-methylstyrene, acrylic acid esters and acrylonitrile. Said other comonomers can be added to the mixture during stage a′).

Preferably, said comonomers represent up to 15% of the total weight of polymerizable monomers.

Preferably, this stage a′) is carried out before any heating of the aqueous suspension.

Optionally, an adjuvant can be added to said suspension during stage a′). Preferably, said adjuvant is chosen from the group consisting of fire retardants, flame retardants, optionally accompanied by a synergist, inorganic suspension stabilizers, such as calcium phosphate or magnesium pyrophosphate, organic suspension stabilizers, such as polyvinylpyrrolidone, polyvinyl alcohol or hydroxyethylcellulose, surfactants, chain-transfer agents, nucleating agents, blowing aids, lubricants, plasticizers, antistatic agents and their mixtures.

Preferably, at least 80% by weight, preferably at least 90% by weight, preferably at least 95% by weight and most preferentially all of the organic peroxide is added to the aqueous suspension comprising the styrene monomers before stage a), more preferentially before any heating of the aqueous suspension.

Preferably, the aqueous suspension comprises water and styrene, preferably in a water/styrene ratio by weight of between 20/80 and 80/20, preferably of between 40/60 and 60/40 and more preferentially of between 45/55 to 55/45.

In one embodiment, the aqueous suspension as defined above comprises an athermanous filler, preferably carbon. The presence of carbon makes it possible to obtain black polystyrene with a lower thermal conductivity than that of white EPS. Said carbon can be added to the mixture during stage a′). It can be accompanied by a compatibilizing compound in order to promote its incorporation in the polystyrene matrix.

Preferably, said carbon is chosen from the group consisting of graphite, carbon black and carbon nanotubes, more preferentially chosen from the group consisting of graphite and carbon black.

Preferably, said carbon represents between 0.1% and 15% by weight, with respect to the weight of the styrene monomers, preferably between 0.5% and 8% by weight, with respect to the weight of the styrene monomers.

### Addition of a Blowing Agent

The process according to the invention can also comprise a stage c) of addition of a blowing agent.

Preferably, said blowing agent is chosen from the group consisting of alkanes comprising between 4 and 6 carbon atoms and their mixtures.

The blowing agent can be added to the aqueous suspension during stage a), before stage b), during stage b) and/or after stage b).

Preferably, the blowing agent is added before stage b), preferably between stage a) and stage b), or during stage b), more preferentially during stage b).

Alternatively, the spherical polystyrene particles obtained at the end of stage b) are sorted by size and then the blowing agent is added to the sorted spherical particles. This mode of application of the process makes possible more precise control of the size of the particles.

Preferably, this stage of addition of the blowing agent is followed by a stage of impregnation with said blowing agent. This impregnation stage makes possible a homogeneous distribution of the blowing agent as far as the core of the polystyrene particles.

Preferably, said blowing agent is chosen from the group consisting of butane, 2-methylbutane, n-pentane, isopentane, cyclohexane and their mixtures.

Preferentially, said blowing agent is n-pentane.

Preferably, the blowing agent is added at contents of between 5% and 10% by weight, with respect to the weight of the styrene monomers.

The present invention will now be further illustrated by the following examples.

### EXAMPLES

In all the examples below, the molecular weight of the product obtained is measured by the method of size exclusion chromatography (SEC) with polystyrene standards.

### Example 1: Synthesis of 1-methoxy-1-(t-amylperoxy)cyclohexane (TAPMC)

A mixture of t-amyl hydroperoxide (TAHP), cyclohexanone and methanol is treated with 70% sulfuric acid at a temperature of between −6° C. and -4° C. In fifteen minutes, an equilibrium mixture of 1-methoxy-1-(t -amylperoxy)cyclohexane, 1,1-di(t-amylperoxy)cyclohexane and unreacted starting materials, cyclohexanone and TAHP, is formed. A small amount (approximately 2%) of cyclohexanone dimethyl ketal (CDMK) is also obtained in the reaction mixture. The reaction mixture is treated with cold water and then the aqueous phase is separated from the organic phase, which is purified by rinsing.

### Example 2: (Comparative) BPO/TBEC

680 g of deionized water with 1.6 g of tricalcium phosphate and 0.027 g of sodium dodecylbenzenesulfonate are added at ambient temperature and with stirring to a 2 liter glass reactor of Büchi type which is resistant to the pressure of 8 bars and which is equipped with a jacket and with specific stirring (stirrer having 3 blades on two levels). 320 g of non-destabilized styrene monomer with 1.44 g of 75% benzoyl peroxide (BPO), sold under the grade name Luperox® A75 by Arkema, and 0.42 g of OO-t-butyl O-2-ethylhexyl monoperoxycarbonate (TBEC), sold under the Luperox® TBEC brand by Arkema, are subsequently added, still with stirring. The reactor is then closed and placed under nitrogen at a pressure between 1.8 and 2 bars. This suspension is subsequently brought to 90° C. over 52 minutes and then maintained at this temperature for 4 hours for the first stationary phase of polymerization. The reaction medium is subsequently heated to 130° C. in 42 minutes and then maintained at this temperature for 2 hours. In this example, the first stationary phase of conversion is essentially provided by the BPO, while the second stationary phase, called the finishing stationary phase of conversion, employs essentially the TBEC. The reaction medium is subsequently rapidly cooled in half an hour in order to make possible the emptying of the reactor in the vicinity of 50° C. After filtration and drying overnight at 50° C., a product is obtained in the form of uniform particles with a diameter of less than 1.4 mm exhibiting a weight-average molecular weight (Mw) of 185 700 g/mol, for a polydispersity of 2.48 and containing 385 ppm of residual styrene monomer.

### Example 3: (Invention) TAPMC Sole Initiator for Conversion of the Styrene

680 g of deionized water with 1.6 g of tricalcium phosphate and 0.029 g of sodium dodecylbenzenesulfonate are added at ambient temperature and with stirring to a reactor identical to that of example 2. 320 g of styrene monomer with 1.76 g of 1-methoxy-1-(tert-amylperoxy)cyclohexane (TAPMC) are subsequently added, still with stirring. This suspension is subsequently brought to 90° C. in 52 minutes. The reactor is then left open and the temperature maintained for 2 h 30 at this temperature for the first stationary phase of polymerization. The reactor is subsequently closed and placed under nitrogen at a pressure between 1.8 and 2 bars. The reaction medium is subsequently heated to 115° C. in 42 minutes and then maintained at this temperature for 2.5 hours. The reaction medium is subsequently rapidly cooled in half an hour in order to make possible the emptying of the reactor in the vicinity of 50° C. In this example, the two stationary phases of conversion are provided by the TAPMC. After filtration and drying of the particles overnight at 50° C., a product is obtained in the form of uniform particles with a diameter of less than 1.4 mm, exhibiting a weight-average molecular weight (Mw) of 190 700 g/mol, for a polydispersity of 2.37 and containing 990 ppm of residual styrene monomer, which value can be considered as satisfying the limiting value of 1000 ppm accepted by the profession (see the document U.S. Pat. No. 6,608,150).

According to this example, it is seen that, despite a first stationary phase temperature 15° C. lower than the half-life temperature for 1 h of the TAPMC (i.e., 90° C. versus 105° C.), the conversion at the end of the cycle remains virtually total and the fundamental characteristics of the resin are preserved. No loss of suspension was observed in the repetition of this example.

The invention makes it possible to reduce the duration of the overall cycle compared to conventional BPO/TBEC conditions.

1-15. (canceled)

16. A process for the polymerization of an aqueous styrene suspension using at least one organic hemiperoxyacetal peroxide, said process comprising a stage a) of maintenance of said aqueous styrene suspension comprising said organic hemiperoxyacetal peroxide at a temperature lower than the half-life temperature for 1 h of said organic hemiperoxyacetal peroxide, for at least 30 minutes.

17. The polymerization process as claimed in claim 16, comprising a stage b), subsequent to stage a), of maintenance of said suspension at a temperature greater than or equal to the half-life temperature for 1 h of said organic hemiperoxyacetal peroxide, for at least 30 minutes.

18. The polymerization process as claimed in claim 16, in which the half-life temperature for 1 h of said organic hemiperoxyacetal peroxide is of between 100° C. and 120° C.

19. The polymerization process as claimed in claim 16, in which stage a) is carried out at a temperature lower by 6 to 25° C. than the half-life temperature for 1 h of said organic hemiperoxyacetal peroxide.

20. The polymerization process as claimed in claim 16, in which stage a) is carried out at a temperature ranging from 80° C. to 100° C.

21. The polymerization process as claimed in claim 16, in which stage a) is carried out at a temperature ranging from 80° C. to less than 100° C.

22. The polymerization process as claimed in claim 17, in which stage b) is carried out at a temperature ranging from 105° C. to 140° C.

23. The polymerization process as claimed in claim 16, wherein the organic peroxide is selected from the group consisting of the hemiperoxyacetals corresponding to the following general formula (I): 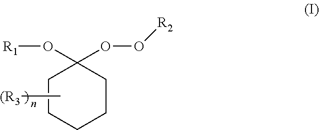
in which formula (I):
R₁ represents a linear or branched C₁-C₄,
R₂ represents a branched C₄-C₁₂,
R₃ represents a linear or branched C₁-C₄, and
n denotes zero or is an integer varying from 1 to 3.

24. The polymerization process as claimed in claim 16, wherein the organic hemiperoxyacetal peroxide(s) is or are selected from the group consisting of 1-methoxy-1-(tert-amylperoxy)cyclohexane (TAPMC), 1-methoxy-1-(t-butylperoxy)cyclohexane (TBPMC), 1-methoxy-1-(t-amylperoxy)-3,3,5 -trimethylcyclohexane, 1-ethoxy-1-(t -amylperoxy)cyclohexane, 1-ethoxy-1-(t-butylperoxy)cyclohexane, 1-ethoxy-1-(t-butyl -3,3,5-peroxycyclohexane and their mixtures.

25. The polymerization process as claimed in claim 16, wherein the organic peroxide is 1-methoxy-1-(tert-amylperoxy)cyclohexane.

26. The polymerization process as claimed in claim 16, comprising the addition of a blowing agent, during stage a), before stage b), during stage b) and/or after stage b).

27. The polymerization process as claimed in claim 16, wherein the aqueous suspension does not comprise OO-t-butyl O-(2-ethylhexyl) monoperoxycarbonate.

28. The polymerization process as claimed in claim 16, wherein the hemiperoxyacetal content is of between 0.05% and 3% by weight, with respect to the weight of the styrene monomers.

29. The polymerization process as claimed in claim 16, wherein at least 80% by weight, of the organic peroxide is added to the aqueous suspension comprising the styrene monomers before stage a).

30. The polymerization process as claimed in claim 16, wherein the aqueous suspension as defined above comprises an athermanous filler.
